(19) United States
(12) Patent Application Publication
(10) Pub. No.: US 2025/0383755 A1
(43) Pub. Date: Dec. 18, 2025

(54) INFORMATION PROCESSING APPARATUS, CONTROL METHOD, AND RECORDING MEDIUM

(71) Applicant: CANON KABUSHIKI KAISHA, Tokyo (JP)

(72) Inventors: KEITA HAGIWARA, Kanagawa (JP); YOUTA SEKI, Tokyo (JP)

(21) Appl. No.: 19/238,164

(22) Filed: Jun. 13, 2025

(30) Foreign Application Priority Data
Jun. 17, 2024 (JP) 2024-097664

(51) Int. Cl. G06F 3/0482; G06F 3/0484; G06F 40/289

(52) U.S. Cl. CPC G06F 3/0482; G06F 3/0484; G06F 40/289

(57) ABSTRACT

An information processing apparatus includes one or more memories storing instructions, and one or more processors in communication with the one or more memories, that upon execution of the stored instructions, configures the one or more processors to acquire voice information included in a moving image, analyze the acquired voice information, based on a result of the analysis, display information in a manner that allows for selection by a user, wherein the display information includes either or both of information indicating a speech error and information indicating a sound type included in the voice information, and in accordance with information being selected by the user, display information regarding a time at which sound corresponding to the selected information is emitted.

### BACKGROUND

### Field

The present disclosure relates to an information processing apparatus, a control method, and a recording medium.

### Description of the Related Art

As video streaming services have become popular, general photographers capture moving images, not as personal recordings, but for the purpose of disclosure to third parties. In the case of streaming a captured moving image, a moving image editor performs editing operations on the moving image. Editing operations include adding characters and images to the captured moving image and clipping a part of the moving image. In the case of editing a moving image, in order to find a portion desired by an editor to be edited, it is necessary to reproduce and check the moving image. An issue occurs whereby, as a record time of the moving image becomes longer, it takes a longer time to find a portion of the video on which editing is to be performed.

Japanese Patent Application Laid-Open No. 2009-163643 discusses a video search apparatus that acquires a start time and an end time at which text data matches voice text data in a moving image, by inputting a keyword, and displays the acquired keyword position onto a video time-line of a monitor. In such a video search apparatus, if a displayed predetermined keyword position is selected, processing that displays a representative image corresponding to the keyword position and reproduces a moving image is performed.

Nevertheless, in the video search apparatus discussed in Japanese Patent Application Laid-Open No. 2009-163643, in order to search for a video scene desired by the user, it is necessary to preliminarily recognize a keyword uttered in a captured moving image. An issue occurs whereby, in a case where the user fails to recognize the keyword because the user does not know or has forgot the keyword, it is difficult to identify the desired video scene.

### SUMMARY OF THE INVENTION

The present disclosure has been devised in view of the above-described issues and is directed to enabling a user to identify a corresponding scene of a moving image that is desired by the user, even in a case where sound in a moving image is not recognized.

According to an aspect of the present disclosure, an information processing apparatus includes one or more memories storing instructions, and one or more processors in communication with the one or more memories, that upon execution of the stored instructions, configures the one or more processors to acquire voice information included in a moving image, analyze the acquired voice information, based on a result of the analysis, display information in a manner that allows for selection by a user, wherein the display information includes either or both of information indicating a speech error and information indicating a sound type included in the voice information, and in accordance with information being selected by the user, display information regarding a time at which sound corresponding to the selected information is emitted.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an information processing apparatus.

FIG. 2 is a diagram illustrating an example of a configuration of a management database according to a first exemplary embodiment.

FIG. 3 is a diagram illustrating an example of a configuration of a moving image edit screen.

FIG. 4 is a diagram illustrating an example of a moving image editing screen according to Modified Example.

FIG. 5 is a diagram illustrating an example of a moving image editing screen according to Modified Example.

FIG. 6 is a flowchart illustrating an example of processing of analyzing voice information.

FIG. 7 is a flowchart illustrating an example of processing of deleting a part of a moving image.

FIG. 8 is a diagram illustrating an example of a configuration of a management database according to a second exemplary embodiment.

FIG. 9 is a diagram illustrating an example of a configuration of a moving image edit screen.

FIG. 10 is a diagram illustrating an example of a configuration of a moving image edit screen.

FIG. 11 is a flowchart illustrating an example of processing of analyzing voice information.

FIG. 12 is a flowchart illustrating an example of processing of list-displaying sound types.

FIG. 13 is a flowchart illustrating an example of processing of creating a stack.

FIG. 14 is a flowchart illustrating an example of processing of creating a stack.

FIG. 15 is a flowchart illustrating an example of processing of displaying a display item onto a time-line.

### DESCRIPTION OF THE EMBODIMENTS

Hereinafter, exemplary embodiments according to the present disclosure will be described with reference to the drawings.

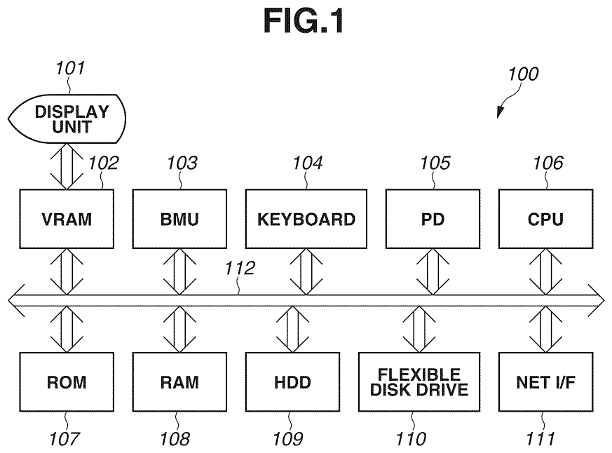

FIG. 1 is a block diagram illustrating an example of a configuration of an information processing apparatus 100 according to the present exemplary embodiment.

The information processing apparatus 100 includes a display unit 101, a video random access memory (VRAM) 102, a bit move unit (BMU) 103, a keyboard 104, a pointing device (PD) 105, a central processing unit (CPU) 106, a read-only memory (ROM) 107, a random access memory (RAM) 108, a hard disk drive (HDD) 109, a flexible disk drive 110, a network interface (I/F) 111, and a bus 112.

The display unit 101 displays icons, messages, menus, and other types of user interface information for performing the management of the information processing apparatus 100.

The VRAM 102 generates content data to be displayed on the display unit 101. The display unit 101 displays the content data generated by the VRAM 102 and transferred to the display unit 101 in accordance with a predetermined rule.

The BMU 103 controls, for example, data transfer between memories (e.g., between the VRAM 102 and another memory), or data transfer between a memory and each input-output (I/O) device (e.g., the network I/F 111).

The keyboard 104 includes various keys for entering characters.

The PD 105 is used to designate an icon, a menu, or another type of content displayed on the display unit 101, or drag and drop an object, for example.

The CPU 106 control devices based on an operating system (OS) stored in the ROM 107, the HDD 109, or the flexible disk drive 110, and various control programs of the information processing apparatus 100, which will be described below. By controlling the display unit 101 and the VRAM 102, the CPU 106 also performs display control on a moving image editing screen to be described below.

The ROM 107 stores various control programs and data.

The RAM 108 includes a work area of the CPU 106, a data save region in error processing, and a control program load region.

The HDD 109 stores data such as each control program to be executed in the information processing apparatus 100, and temporarily-stored data.

The network I/F 111 performs communication with another information processing apparatus and a printer via a network.

The bus 112 includes an address bus, a data bus, and a control bus.

Control programs are provided to the CPU 106 from the ROM 107, the HDD 109, and the flexible disk drive 110. Alternatively, control programs may be provided to the CPU 106 from another information processing apparatus via network by going through the network I/F 111.

The information processing apparatus 100 may include a touch panel in place of the keyboard 104 and the PD 105.

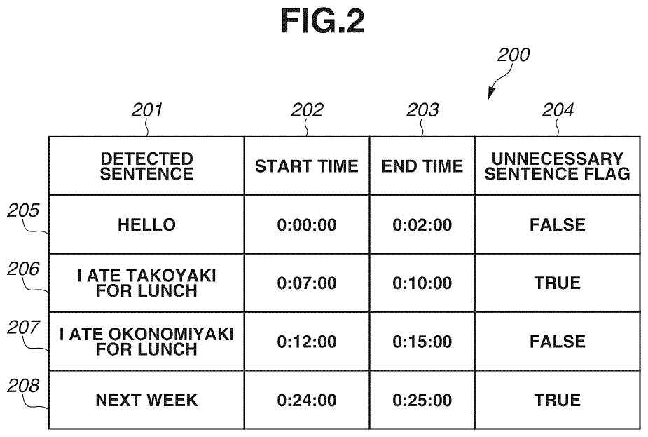

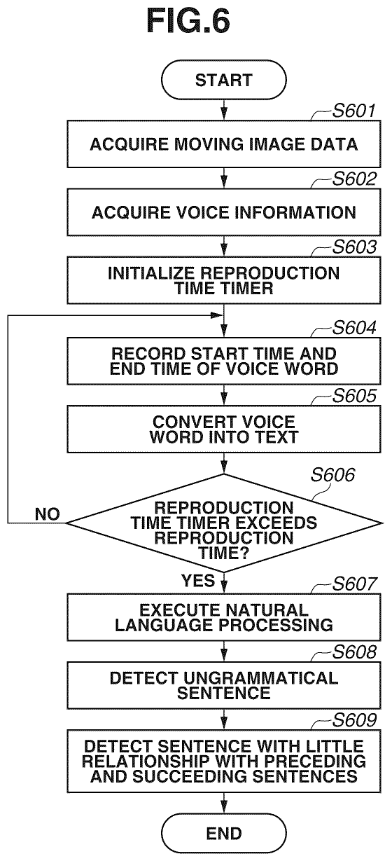

FIG. 2 is a diagram illustrating an example of a configuration of a management database 200 to be managed by the information processing apparatus 100 according to the present exemplary embodiment. Processing of recording each record into the management database 200 will be described with reference to the flowchart in FIG. 6. A record that is obtained by analyzing voice information of a moving image and serves as analysis data is recorded in the management database 200.

One management database 200 is generated for one moving image.

Each record recorded in the management database 200 includes sentence data 201 representing a sentence as detected by a natural language processing operation, a start time 202 and an end time 203 of a period during which the sentence is uttered in a moving image, and a flag 204 indicating whether the sentence is unnecessary for or unrelated to the moving image, all of which are stored in association with each other. The flag 204 is set to “TRUE” by default. It should be understood that sentence data 201 may include not only a complete sentence but also a phrase or individual words.

The sentence 201 detected in the natural language processing is a sentence obtained by converting a spoken comment that is incorrectly spoken or wrongly made (or restated) in the moving image, into a text.

Four records 205 to 208 are recorded in the management database 200 illustrated in FIG. 2. The records 205 and 208 are data including sentences detected in the natural language processing as ungrammatical sentences. On the other hand, the records 206 and 207 are data including sentences detected in the natural language processing as sentences with little relationship with preceding and succeeding sentences.

In this example, the four records are recorded, but a larger number of records may be recorded.

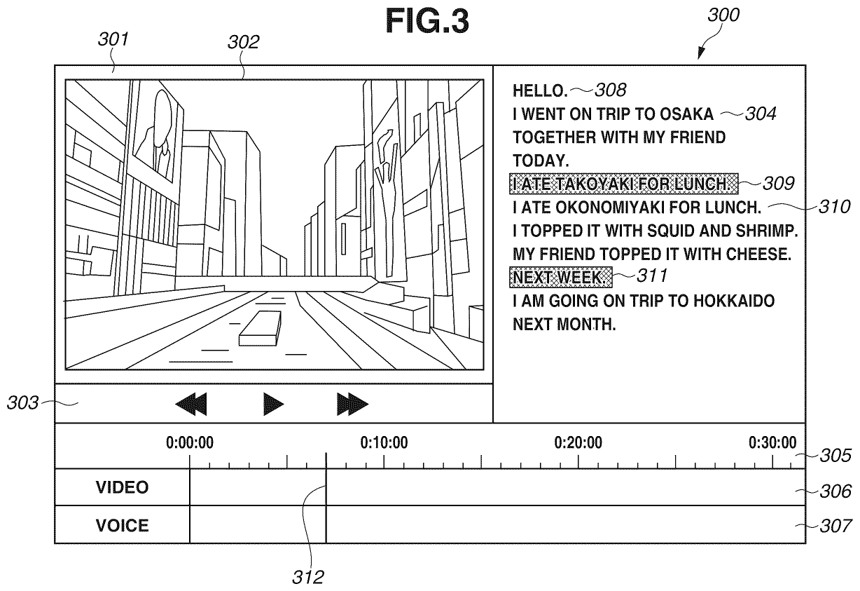

FIG. 3 is a diagram illustrating an example of a moving image editing screen 300 according to the present exemplary embodiment. The moving image editing screen 300 is displayed on the display unit 101 in accordance with an operation of activating a program in a case where the user reproduces or edits a moving image.

A moving image display region 301 is a region in which moving image data 302 is displayed. The moving image data 302 is data stored in the HDD 109, for example.

A function display region 303 is a region in which operation items related to standard functions to be executed when a moving image is reproduced, such as reproduction, pause, and skip, are displayed.

A text region 304 is a region in which a sentence obtained by converting a voice record extracted from the moving image data 302, into a text is displayed.

A time-line region 305 is a region in which a time-line that indicates a time axis of the moving image data 302, and serves as a display item is displayed.

A video crop region 306 is included in the time-line region 305, and is a region in which a video crop of the moving image data 302 is displayed.

A voice crop region 307 is included in the time-line region 305, and is a region in which a voice crop of the moving image data 302 is displayed.

In the text region 304 illustrated in FIG. 3, sentences 308 to 311 are displayed.

The sentences 308 and 311 correspond to the records 205 and 208 in the management database 200, and each serve as an example of a sentence having improper grammatical structure. A sentence having improper grammar is detected as a wrongly-made (or improper) comment.

The sentences 309 and 310 correspond to the records 206 and 207 in the management database 200, and each serve as an example of a sentence with little relationship with preceding and succeeding sentences. The sentence with little relationship with preceding and succeeding sentences is detected as a wrongly-made (restated) comment.

The sentences 309 and 311 that have the flag 204 set in the management database 200 to “TRUE”, and the sentences 308 and 310 that have the flag 204 set to “FALSE” are displayed in different modes. Specifically, the sentences 309 and 311 having the flag 204 set to “TRUE” are highlighted by setting the color of the background to a different color from other parts of the display.

On the moving image editing screen 300, in a case where sentences have improper grammar like the sentences 308 and 311, the user can select a corresponding sentence. Each time the user selects a sentence, the sentences 308 and 311 switch between emphasized display and normal display (display set when emphasized display is cancelled). At this time, also in the management database 200, the flag 204 of a record corresponding to the selected sentence switches between “TRUE” and “FALSE”.

In a case where sentences are sentences with little relationship with preceding and succeeding sentences like the sentences 309 and 310, by the user selecting a sentence not being highlighted, a sentence to be highlighted switches.

At this time, in the management database 200, the flag 204 of a record corresponding to the selected sentence switches between “TRUE” and “FALSE”.

A reproduction position item 312 is a display item indicating a reproduction position of a moving image in the time-line region 305. In a case where the user selects the highlighted sentence 309, based on the start time 202 in the management database 200, the reproduction position item 312 is displayed after moving to a reproduction position corresponding to the selected sentence. In the moving image display region 301, a thumbnail image in the moving image data 302 that corresponds to the reproduction position of the reproduction position item 312 is displayed. In a case where the user selects the highlighted sentence 309, the moving image data 302 may be reproduced from the moved reproduction position of the reproduction position item 312. A sentence to be selected is not limited to the sentence 309, and the same applies to a case where the sentence 311 is selected.

By displaying the moving image editing screen 300 in this manner, it is possible to easily identify a scene of a comment wrongly made in a moving image. Even in a case where there is a plurality of wrongly-made comments, it is possible to identify a corresponding scene for each wrongly-made comment.

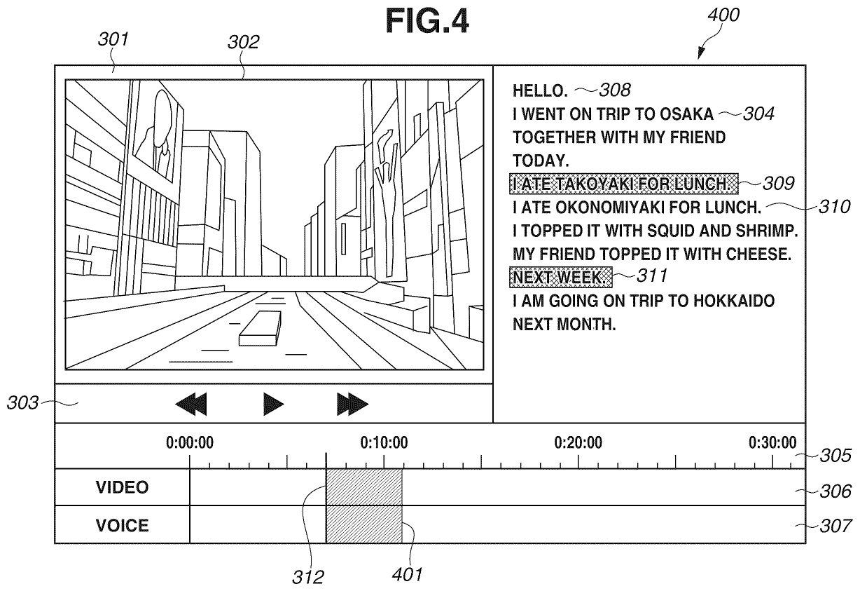

FIG. 4 is a diagram illustrating an example of a moving image editing screen 400 according to Modified Example. The components similar to those in the moving image editing screen 300 in FIG. 3 are assigned the same reference numerals, and the description will be omitted.

In this example, a range item 401 indicating a range of a moving image is displayed in the time-line region 305. The range item 401 highlights a range of a moving image. In a case where the user selects the highlighted sentence 309, based on the start time 202 and the end time 203 corresponding to the record 206 in the management database 200, the range item 401 is displayed over a range from a start time of 0:07:00 to an end time of 0:11:00. The range item 401 is highlighted by setting its color to a color different from a background color of the time-line region 305. A sentence to be selected is not limited to the sentence 309, and the same applies to a case where the sentence 311 is selected.

By displaying the moving image editing screen 400 in this manner, it is possible to check a position on the entire time-line of a comment wrongly made in a moving image. It is also possible to check an end position in addition to a start position of a comment wrongly made in a moving image.

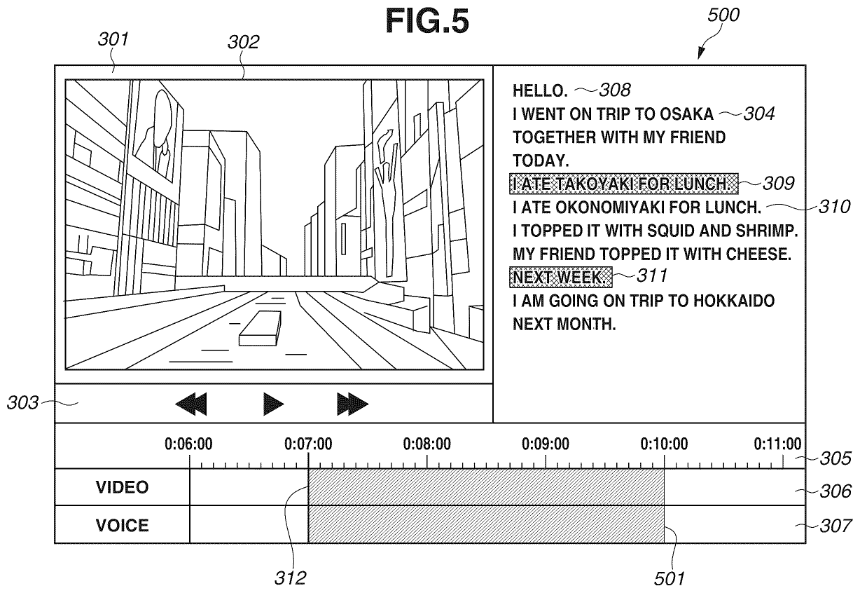

FIG. 5 is a diagram illustrating an example of a moving image editing screen 500 according to Modified Example. The components similar to those in the moving image editing screen 300 in FIG. 3 are assigned the same reference numerals, and the description will be omitted.

In this example, in accordance with a highlighted sentence being selected, a time axis of a time-line displayed in the time-line region 305 is displayed in an enlarged manner. In a case where the user selects the highlighted sentence 309, based on the start time 202 and the end time 203 corresponding to the record 206 in the management database 200, the time axis of the time-line is enlarged during a period from one second before the start time of 0:07:00 to one second after the end time of 0:10:00. In addition, a range item 501 is displayed in an enlarged manner over a range from the start time of 0:07:00 to the end time of 0:10:00 of the enlarged time-line. A sentence to be selected is not limited to the sentence 309, and the same applies to a case where the sentence 311 is selected.

A range in which the time axis of the time-line is enlarged is not limited to the period from one second before the start time to one second after the end time, and may be a period from a first predetermined time before the start time to a second predetermined time after the end time, or the user may be enabled to set an arbitrary time.

By displaying the moving image editing screen 500 in this manner, it is possible to finely check a start time or an end time of a comment wrongly made in a moving image. Accordingly, it is possible to easily designate a range to be deleted, when the user deletes a partial scene of a moving image.

The range indicated by the range item 501 can be adjusted in accordance with a user's operation of moving the position of a start time or the position of an end time of the range item 501. At this time, in the management database 200, the start time 202 and the end time 203 of a record corresponding to a selected sentence are also subjected to addition or subtraction by the adjusted amount.

FIG. 6 is a flowchart illustrating an example of processing of analyzing voice information according to the present exemplary embodiment. The processing in FIG. 6 and flowcharts to be described below are implemented by the CPU 106 of the information processing apparatus 100 executing programs stored in the HDD 109 and the like. The description will now be given assuming that a speech error included in voice information of the moving image data 302 illustrated in FIG. 3 is detected as a sentence.

In step S601, the CPU 106 acquires moving image data designated by the user, by reading the moving image data.

In step S602, the CPU 106 acquires voice information by extracting a voice record serving as voice information, from the acquired moving image data.

In step S603, the CPU 106 generates a reproduction time timer for managing a moving image reproduction time, and initializes the reproduction time timer. The reproduction time timer counts a time in accordance with the progress of a time-line of a moving image. The CPU 106 starts the counting of the reproduction time timer simultaneously with the reproduction of the voice record.

In steps S604 to S609, the CPU 106 analyzes the voice record.

In step S604, the CPU 106 reads a start time and an end time of each voice word from the reproduction time timer when a speech is made in the voice record, and records the start time and the end time.

In step S605, the CPU 106 converts a voice word spoken in the voice record, into a text, and records the text. Accordingly, a voice record included in the moving image data 302 is converted as a sentence. At this time, the CPU 106 may output a sentence converted from the voice record.

In step S606, the CPU 106 determines whether the reproduction time timer exceeds a reproduction time of the moving image. In a case where the reproduction time timer exceeds the reproduction time (YES in step S606), the processing proceeds to step S607. On the other hand, in a case where the reproduction time timer does not exceed the reproduction time (NO in step S606), the processing returns to step S604, and the processing is repeated until the reproduction time timer exceeds the reproduction time.

In step S607, the CPU 106 performs natural language processing on a recorded text. There are various known methods as methods of the natural language processing, and the method of the natural language processing to be executed is not limited.

In step S608, the CPU 106 detects an ungrammatical sentence from the result of the natural language processing.

The CPU 106 records the detected sentence, and a start time and an end time of a period during which the sentence is spoken in the moving image, into the management database 200 as a record in association with each other. The start time and the end time can be acquired from a start time and an end time recorded for each voice word in step S604. That is, a start time to be recorded corresponds to a start time of an initial voice word in the detected sentence. On the other hand, an end time to be recorded corresponds to an end time of a last voice word in the detected sentence.

At this time, in a case where the detected sentence is a sentence completed by one word, the flag 204 of a record corresponding to the sentence completed by one word is set to “FALSE”. The sentence completed by one word is an independent word such as a greeting including “Hello” like the sentence 308, for example, or exclamation. Accordingly, in the management database 200, the flag 204 of the record 205 corresponding to the sentence 308 is set to “FALSE”.

In step S609, the CPU 106 detects a sentence with little relationship with preceding and succeeding sentences from the result of the natural language processing. For each pair of preceding and succeeding sentences, the CPU 106 records the detected sentence, and a start time and an end time of a period during which the sentence is spoken in the moving image, into the management database 200 as a record in association with one another.

At this time, the flag 204 of a record corresponding to the succeeding sentence of the preceding and succeeding sentences, or corresponding to the last sentence is set to “FALSE”. The sentence with little relationship is, for example, a sentence like the sentences 309 and 310. In this case, it can be determined that the succeeding sentence 310 or the last sentence 310 is a correct sentence. Accordingly, in the management database 200, the flag 204 of the record 207 corresponding to the sentence 310 is set to “FALSE”.

In this manner, by analyzing voice information of moving image data, it is possible to detect a speech error included in the voice information, as a sentence, and record a record in which the detected sentence and a start time and an end time of a period during which the sentence is spoken in the moving image are associated with one another, into the management database 200.

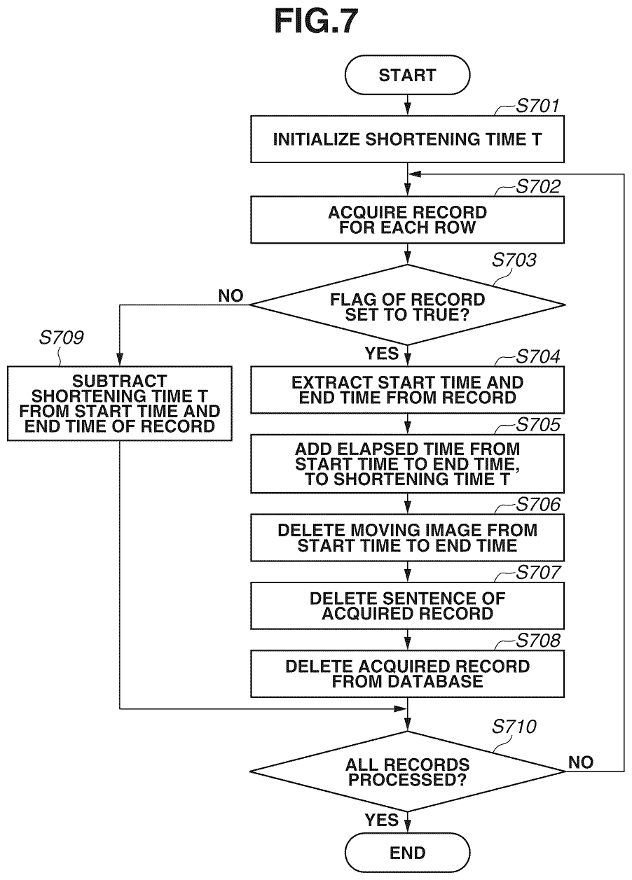

FIG. 7 is a flowchart illustrating an example of processing of deleting a part of a moving image according to the present exemplary embodiment. Hereinafter, the case of automatically deleting a scene corresponding to a speech error point in moving image data will be described, but the scene may be deleted in accordance with a user operation.

In step S701, the CPU 106 initializes a value of a shortening time T. Here, the shortening time T is a total time to be shortened by a moving image being deleted, and is a value to be added in step S705 to be described below.

In step S702, the CPU 106 acquires a record from the management database 200 associated with the moving image data, for each row from the beginning.

In step S703, the CPU 106 determines whether a flag of the acquired record is set to “TRUE”. In a case where the flag is set to “TRUE” (YES in step S703), the processing proceeds to step S704.

In step S704, the CPU 106 extracts information regarding a start time and an end time, from the acquired record. The acquired record includes information regarding the start time 202 and the end time 203 recorded in the management database 200.

In step S705, the CPU 106 calculates an elapsed time from the start time to the end time, from the extracted information regarding the start time to the end time, and adds the calculated elapsed time to a value of the shortening time T. Here, in a case where the record 206 in the management database 200 is acquired, because a start time and an end time of the record 206 are 0:07:00 and 0:10:00, the elapsed time is calculated to be three seconds. Accordingly, three seconds are added to the value of the shortening time T. Subsequently, in a case where the record 208 in the management database 200 is acquired, because an elapsed time of the record 208 is calculated to be one second, one second is added to the shortening time T and the value of the shortening time T becomes four seconds.

In step S706, the CPU 106 deletes a scene of a moving image from the extracted start time to end time. The CPU 106 may delete only a voice by leaving a video.

In step S707, the CPU 106 deletes a sentence corresponding to the acquired record, from the text converted from the voice word and recorded in step S605 described above. The acquired record includes information regarding the detected sentence 201 recorded in the management database 200.

In step S708, the CPU 106 deletes the same record as the acquired record from the management database 200. By a record being deleted from the management database 200, a sentence corresponding to the deleted record is also deleted from the text region 304 on the moving image editing screen 400.

On the other hand, in a case where it is determined in step S703 that the flag is set to “FALSE” (NO in step S703), the processing proceeds to step S709.

In step S709, the CPU 106 extracts information regarding a start time and an end time, from the acquired record, subtracts the value of the shortening time T from the extracted start time and end time, and records the start time and the end time which have been subjected to updating by the subtraction, into the management database 200. For example, in a case where the record 207 is acquired and the value of the shortening time T is three seconds, three seconds are subtracted from a start time and an end time of the record 207 in the management database 200, and the start time and the end time are updated to a start time of 0:09:00 and an end time of 0:12:00. In the case of deleting only a voice by leaving a video, the CPU 106 does not perform the processing in step S709.

In step S710, the CPU 106 determines whether all records have been processed. In a case where all records have been processed (YES in step S710), the processing in the flowchart in FIG. 7 ends. On the other hand, in a case where all records have not been processed (NO in step S710), the processing returns to step S702, and the processing is repeated until all records are processed.

In this manner, by a deleting a scene corresponding to a point in the scene where there is speech error, it is possible to reduce burden on an editing work of the user.

As described above, according to the present exemplary embodiment, based on an analysis result of voice information, a sentence obtained by converting a speech error into a text is displayed as information regarding a speech error,. Furthermore, as information regarding a time at which sound corresponding to the displayed sentence is emitted, a display item indicating a time at which the sound is emitted is displayed. Accordingly, even in a case where the user does not recognize a speech error made in a moving image, the user can easily identify a desired scene in the moving image (e.g., a scene required to be edited). Because a speech error is especially expected to be edited as compared with other scenes, identifying a speech error is advantageous. In this manner, by enabling the user to easily identify the scene, it is possible to reduce work burden in editing a moving image.

In the first exemplary embodiment, the case of displaying a sentence obtained by converting a speech error made in a moving image into a text is provided. In a second exemplary embodiment, the case of displaying information regarding the type of sound emitted in a moving image will be described. The configuration of the information processing apparatus 100 is similar to that in FIG. 1, and the description will be omitted.

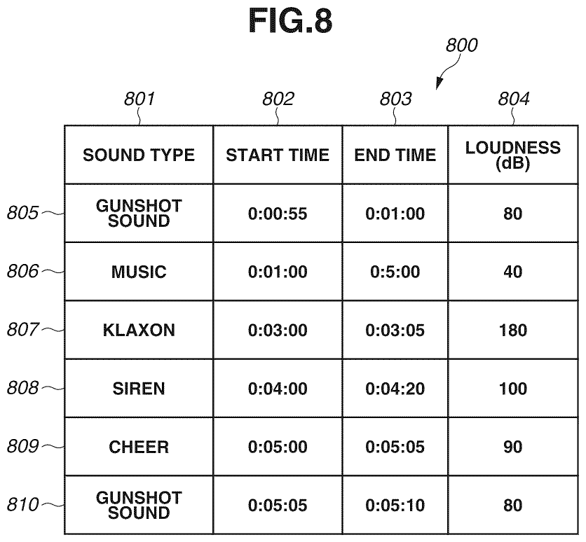

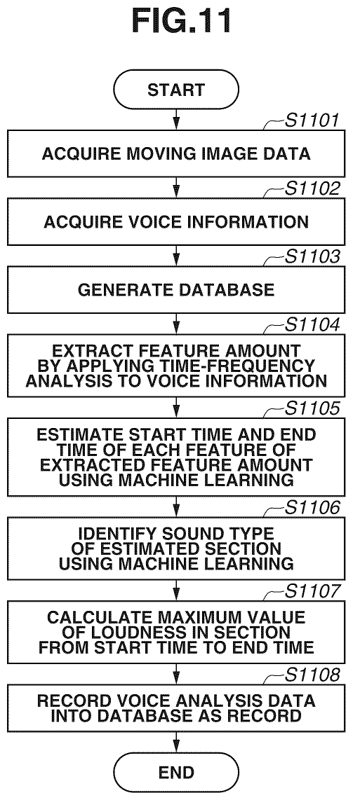

FIG. 8 is a diagram illustrating an example of a configuration of a management database 800 to be managed by an information processing apparatus 100 according to the present exemplary embodiment. The processing of storing each record into the management database 800 will be described with reference to a flowchart in FIG. 11 to be described below. A record that is obtained by analyzing voice information of a moving image and serves as analysis data is recorded in the management database 800. One management database 800 is generated for one moving image.

For each record, a sound type 801 of sound detected by analyzing voice information, a start time 802 and an end time 803 of a period during which sound is emitted, and loudness 804 are recorded in the management database 800 in association with one another. A value of the loudness is a numerical value, and a unit of the loudness is decibel (dB).

Six records 805 to 810 are recorded in the management database 800 illustrated in FIG. 8. The sound type of the records 805 and 810 is gunshot sound, the record 805 is associated with a start time of 0:00:55 and an end time of 0:01:00, and the record 810 is associated with a start time of 0:05:05 and an end time of 0:05:10. The sound type of the record 806 is music, and the record 806 is associated with a start time of 0:01:00 and an end time of 0:05:00. The sound type of the record 807 is klaxon, and the record 807 is associated with a start time of 0:03:00 and an end time of 0:03:05. The sound type of the record 808 is siren, and the record 808 is associated with a start time of 0:04:00 and an end time of 0:04:20. The sound type of the record 809 is cheer, and the record 809 is associated with a start time of 0:05:00 and an end time of 0:05:05. The gunshot sound, the music, the klaxon, the siren, and the cheer are words representing sound types. Aside from these, the sound type may be notification sound or wind sound. Among the sound types, the gunshot sound, the music, the klaxon, the siren, the notification sound, and the wind sound each correspond to an example of sound other than voice uttered by a person. Among the sound types, the gunshot sound, the music, the klaxon, the siren, the notification sound, and the wind sound each correspond to an example of environmental sound.

In this example, the sixth records are recorded, but a larger number of records may be recorded.

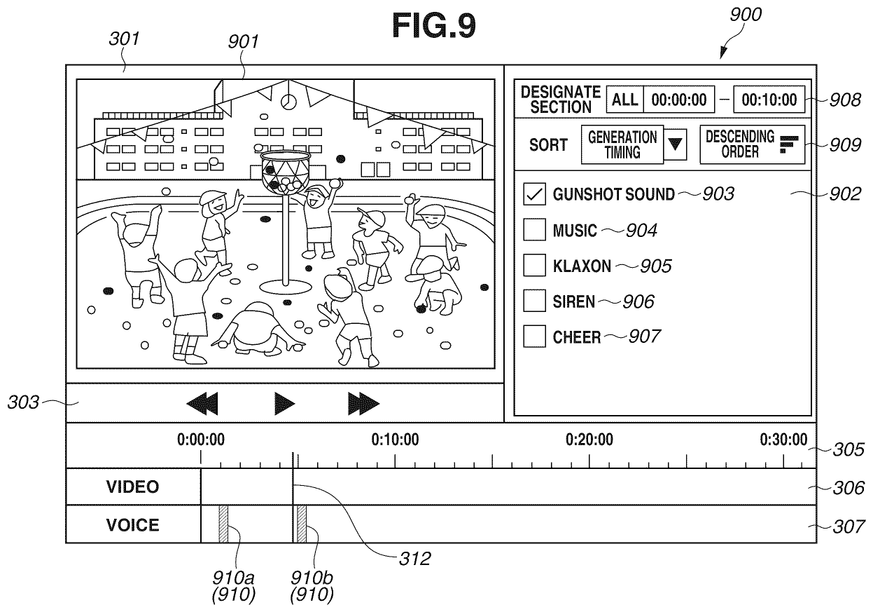

FIG. 9 is a diagram illustrating an example of a moving image editing screen 900 according to the present exemplary embodiment. On the moving image editing screen 900, the moving image display region 301, the function display region 303, the time-line region 305, the video crop region 306, the voice crop region 307, and the reproduction position item 312 are components similar to those in FIG. 3, and the description will be omitted. In addition, moving image data 901 is displayed in the moving image display region 301.

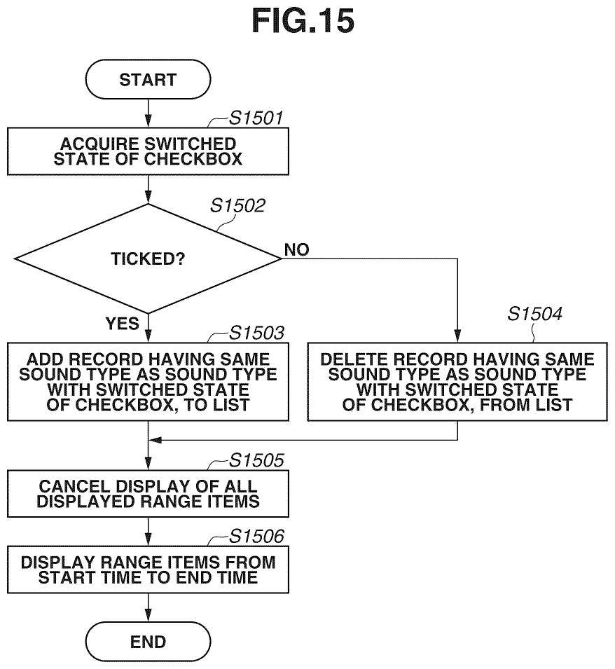

A list display region 902 is a region in which sound types of sound emitted in moving image are list-displayed. Sound types 903 to 907 displayed in the list display region 902 respectively correspond to the records 805 to 810 in the management database 800. Checkboxes respectively corresponding to the sound types are displayed in the list display region 902, and the states of checkboxes switch in accordance with a user's selecting operation. If the state of a checkbox switches, processing in a flowchart in FIG. 15 to be described below is executed. The selection method is not limited to the selection of a checkbox, and it is sufficient that a selected sound type can be identified.

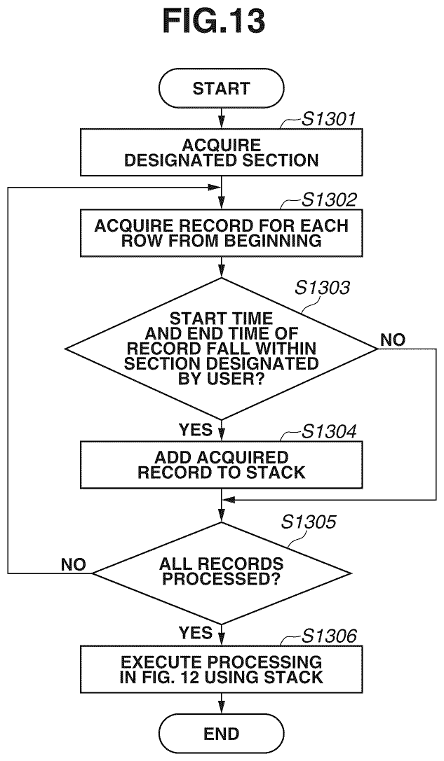

A section designation region 908 is a region in which a parameter to be set when a section of a moving image is designated by the user is displayed. The user can designate an arbitrary section on the time-line region 305 using the PD 105 or the like. In a left textbox in the section designation region 908, a start time is displayed based on the designated section. In a right textbox in the section designation region 908, an end time is displayed based on the designated section. Alternatively, the user may directly enter a start time and an end time of a section to be designated, into textboxes in the section designation region 908 using the keyboard 104 or the like. By the parameter in the section designation region 908 being changed, the processing in the flowchart in FIG. 13 to be described below is executed, and only sound types in the changed section are displayed in the list display region 902.

A sort designation region 909 is a region in which a parameter to be set when sort is designated by the user is displayed. In the sort designation region 909, a pull-down menu from which a sort reference item can be selected, and a display order switch button for switching an ascending order and a descending order are displayed.

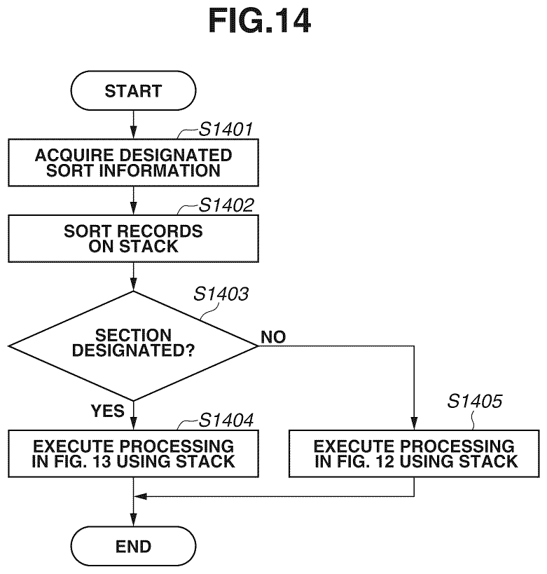

In the list display region 902, the sound type items are displayed with being sorted based on the selected sort reference item and the display order switch button. Sort reference items include a loudness, a frequency, a time length, and a generation timing. For example, in a case where the loudness item is selected, based on the loudness 804 in the management database 800, the sound type items are sorted in a descending order or an ascending order of loudness. In a case where the frequency item is selected, based on the number of records in which the same sound type is recorded in the sound type 801 in the management database 800, the sound type items are sorted in a descending order or an ascending order of the frequency of emitted sound. In a case where the time length is selected, based on the start time 802 and the end time 803 of the management database 800, the sound type items are sorted in a descending order or an ascending order of the length of a time from the start time to the end time. In a case where a generation timing is selected, based on the start time 802 in the management database 800, the sound type items are sorted in an ascending order or a descending order of the start time. By the parameter in the sort designation region 909 being changed, processing in a flowchart in FIG. 14 to be described below is executed, and a display order of sound types is determined.

A range item 910 is a display item indicating a range of a moving image during which sound corresponding to a sound type selected in the list display region 902 is emitted, on the time-line region 305. The range item 910 highlights the range of the moving image. Here, in a case where the user selects the sound type 903 in the list display region 902, based on the start times 802 and the end times 803 corresponding to the records 805 and 810 in the management database 800, two range items 910a and 910b are displayed. Specifically, the range item 910a is displayed over a range from a start time of 0:00:55 to an end time of 0:01:00, and the range item 910b is displayed over a range from a start time of 0:05:05 to an end time of 0:05:10. In a case where records with the same sound type are recorded in the management database 800, each time sound of the same type is emitted, the range item 910a or 910b is displayed. A range in which the range items 910a and 910b are displayed is determined by the processing in a flowchart in FIG. 15 to be described below. A sound type to be selected is not limited to the sound type 903, and the same applies to cases where the sound types 904 to 907 are selected.

In a case where the user selects the range item 910a or 910b, moving image data may be reproduced from the start time of the range item 910a or 910b.

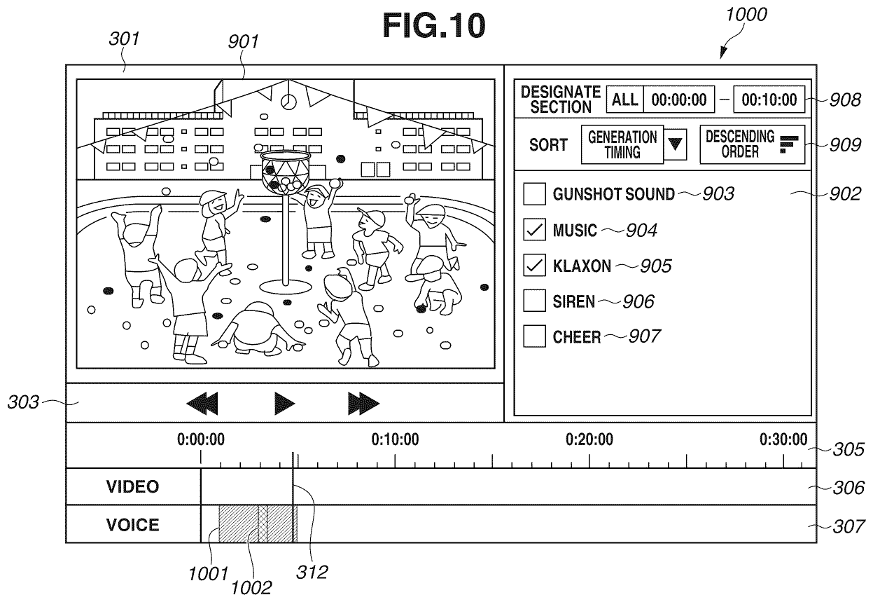

FIG. 10 is a diagram illustrating an example of a moving image editing screen 1000 according to the present exemplary embodiment. The components similar to those in the moving image editing screen 900 in FIG. 9 are assigned the same reference numerals, and the description will be omitted.

The user can select a plurality of sound types from among the sound types 903 to 907 displayed in the list display region 902. Here, in a case where the user selects the sound types 904 and 905 in the list display region 902, based on the start times 802 and the end times 803 corresponding to the records 806 and 807 in the management database 800, two range items 1001 and 1002 are displayed. Specifically, the range item 1001 is displayed over a range from a start time of 0:01:00 to an end time of 0:05:00, and the range item 1002 is displayed over a range from a start time of 0:03:00 to an end time of 0:03:05.

At this time, the range items 1001 and 1002 are displayed in such a manner that the user can identify that the range item 1001 corresponds to the sound type 904 and the range item 1002 corresponds to the sound type 905. Specifically, the range item 1001 and characters of the sound type 904 are displayed in a first color, and the range item 1002 and characters of the sound type 905 are displayed in a second color different from the first color. Nevertheless, it is sufficient that the user can identify a sound type to which a range item corresponds, and a method by which the user caused to identify the sound type is not limited. Even if a plurality of (three or more) sound types is selected, it is possible to similarly display a range item for each sound type.

The range items 1001 and 1002 are displayed in such a manner that the user can identify that the range from the start time to the end time of the range item 1001, and the range from the start time to the end time of the range item 1002 overlap. Specifically, the range item 1002 is displayed in a hatching display mode in such a manner that the range item 1001 is transparently displayed. Nevertheless, it is sufficient that the user can identify that the ranges of the range items overlap, and a display mode is not limited.

In a case where the ranges of the range items overlap, a range item to be preferentially displayed may be determined in accordance with a display order in the list display region 902.

By displaying moving image edit screens 900 and 1000 in this manner, it is possible to easily identify a scene in moving image based on a sound type. Even in a case where there are a plurality of sound types, it is possible to identify a corresponding scene for each sound type.

FIG. 11 is a flowchart illustrating an example of processing of analyzing voice information according to the present exemplary embodiment. The processing in FIG. 11 and flowcharts to be described below are implemented by the CPU 106 of the information processing apparatus 100 executing programs stored in the HDD 109 and the like. The description will now be given assuming that a sound type included in voice information of the moving image data 901 illustrated in FIG. 9 is detected.

In step S1101, the CPU 106 acquires moving image data designated by the user, by reading the moving image data.

In step S1102, the CPU 106 acquires voice information by extracting a voice record serving as voice information, from the acquired moving image data.

In step S1103, the CPU 106 generates a management database. A management database to be generated is a blank database in which no record is recorded.

In steps S1104 to S1107, the CPU 106 analyzes the voice record.

In step S1104, the CPU 106 extracts a feature amount by applying time-frequency analysis to the acquired voice record, for example. Here, a feature amount to be extracted is a frequency feature per time of voice information.

In step S1105, the CPU 106 estimates a start time and an end time of a section in which sound of some sort is emitted, from the extracted feature amount by applying a regression procedure of machine learning, for example. In this step, start times and end times of sections in which sounds of the records 805 to 810 are emitted, and a start time and an end time of a section in which sound of some sort other than the records is emitted are estimated.

In step S1106, the CPU 106 identifies the sound type of sound emitted in each estimated section, based on the extracted feature amount by applying a classification method of machine learning, for example. Here, the number of identifiable sound types is equal to the number of categories into which sound types can be classified by machine learning. Accordingly, in accordance with the performance of the information processing apparatus 100, a sound type may be identified by a classification method of machine learning having large classification categories. In the present exemplary embodiment, sound types are identified in the sections in which sounds corresponding to the records 805 to 810 are emitted, and a sound type cannot be identified in a section in which sound of some sort other than the sounds is emitted.

In step S1107, the CPU 106 calculates loudness of each sound in the sections in which the sound types have been identified. More specifically, the CPU 106 calculates a maximum value of loudness.

In step S1108, the CPU 106 creates voice analysis data, and records the created voice analysis data by adding the created voice analysis data to the management database 800 as a record. The voice analysis data includes information regarding the sound type identified in step S1106, the start time and the end time estimated in step S1105, and the loudness calculated in step S1107. The information regarding the sound type identified in step S1106 is recorded in such a manner as to correspond to the sound type 801 in the management database 800. The information regarding the start time and the end time estimated in step S1105 is recorded in such a manner as to correspond to the start time 802 and the end time 803 in the management database 800. The information regarding the loudness calculated in step S1107 is recorded in such a manner as to correspond to the loudness 804 in the management database 800.

By analyzing voice information included in moving image data, in this manner, in a management database, based on an analysis result, information regarding a sound type and a start time and an end time of a period during which sound is emitted are recorded in association with one another.

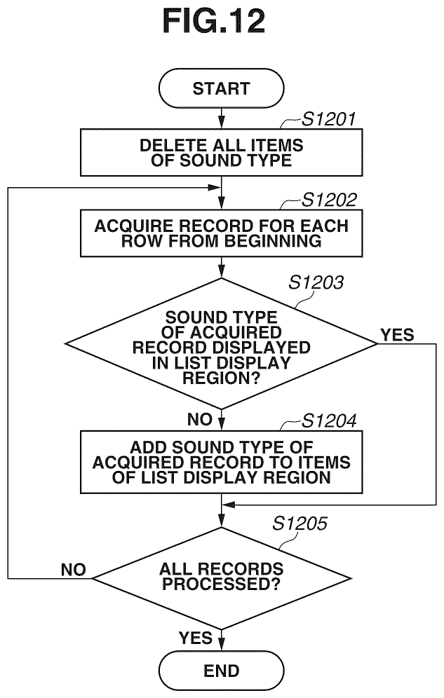

FIG. 12 is a flowchart illustrating an example of processing of list-displaying sound types on a moving image edit screen. The processing in the flowchart in FIG. 12 is started by the information processing apparatus 100 newly reading moving image data to be reproduced and edited.

In step S1201, the CPU 106 deletes all sound type items displayed in the list display region 902.

In step S1202, the CPU 106 acquires a record from the management database 800 associated with the moving image data, for each row from the beginning. At this time, in a case where the user designates a section or sort in the section designation region 908 or the sort designation region 909, the CPU 106 acquires a record with reference to a stack created in a flowchart in FIG. 13 or 14 to be described below, in place of the management database 800.

In step S1203, the CPU 106 determines whether a sound type of the acquired record is displayed in the list display region 902. In a case where the same sound type is not displayed in the list display region 902 (NO in step S1203), the processing proceeds to step S1204. In a case where the processing proceeds to step S1203 for the first time since the processing in the flowchart in FIG. 12 is started, because all sound type items are deleted in step S1201, it is determined that the same sound type is not displayed in the list display region 902 (NO in step S1203), and the processing proceeds to step S1204. On the other hand, in a case where the same sound type is displayed in the list display region 902 (YES in step S1203), the processing proceeds to step S1205.

In step S1204, the CPU 106 adds the sound type of the acquired record to the sound type items in the list display region 902 and displays the sound type.

In step S1205, the CPU 106 determines whether all records have been acquired from the management database 800. At this time, in a case where the user designates a section or sort in the section designation region 908 or the sort designation region 909, the CPU 106 determines whether all records have been acquired from the stack created in the flowchart in FIG. 13 or 14 to be described below, in place of the management database 800.

In a case where all records have been acquired (YES in step S1205), the processing in the flowchart in FIG. 12 ends. On the other hand, in a case where there is a record not acquired, the processing returns to step S1202, and the CPU 106 acquires the next record.

FIG. 13 is a flowchart illustrating an example of processing of creating a stack for displaying a list of sound types in a case where a section is designated.

In step S1301, the CPU 106 acquires information regarding the section designated in the section designation region 908 (i.e., information regarding the start time and the end time).

In step S1302, the CPU 106 acquires a record from the management database 800 associated with the moving image data, for each row from the beginning. At this time, in a case where the user designates sort in the sort designation region 909, the CPU 106 acquires a record with reference to the stack created in a flowchart in FIG. 14 to be described below.

In step S1303, the CPU 106 determines whether the start time and the end time recorded in the acquired record fall within the section designated by the user in the section designation region 908. In this step, in a case where both the start time and the end time recorded in the record fall within the section in the section designation region 908, the CPU 106 determines that the start time and the end time fall within the section designated by the user. Nevertheless, in a case where either the start time or the end time recorded in the acquired record falls within the section designated by the user, the CPU 106 may determine that the start time and the end time fall within the section designated by the user. In a case where the start time and the end time fall within the section (YES in step S1303), the processing proceeds to step S1304. In a case where the start time and the end time do not fall within the section (NO in step S1303), the processing proceeds to step S1305.

In step S1304, the CPU 106 adds the acquired record to a stack.

In step S1305, the CPU 106 determines whether all records have been acquired from the management database 800. At this time, in a case where the user designates sort in the sort designation region 909, the CPU 106 determines whether all records have been acquired from the stack created in the flowchart in FIG. 14 to be described below, in place of the management database 800.

In a case where all records have been acquired (YES in step $1305), the processing proceeds to step S1306. On the other hand, in a case where there is a record not acquired, the processing returns to step S1302, and the CPU 106 acquires the next record.

In step S1306, the CPU 106 executes the processing in the flowchart in FIG. 12 using the created stack. After the processing in step S1306, the processing in the flowchart in FIG. 13 ends.

FIG. 14 is a flowchart illustrating an example of processing of creating a stack for displaying a list of sound types in a case where the user designates sort.

In step S1401, the CPU 106 acquires information regarding sort designated in the sort designation region 909.

In step S1402, the CPU 106 copies all records to a stack from the management database 800 associated with the moving image data, and sorts the record based on the acquired information regarding the sort.

In step S1403, the CPU 106 determines whether the user designates a section in the section designation region 908. In a case where a section is designated (YES in step S1403), the processing proceeds to step S1404. In a case where a section is not designated (NO in step S1403), the processing proceeds to step S1405.

In step S1404, the CPU 106 executes the processing in the flowchart in FIG. 13 using the sorted stack. After the processing in step S1404, the processing in the flowchart in FIG. 14 ends.

In step S1405, the CPU 106 executes the processing in the flowchart in FIG. 12 using the sorted stack. After the processing in step S1405, the processing in the flowchart in FIG. 14 ends.

FIG. 15 is a flowchart illustrating an example of processing of displaying a display item corresponding to a sound type selected in the list display region 902, onto a time-line.

In step S1501, the CPU 106 acquires the state of a checkbox that has been switched by a user operation, among checkboxes displayed in the list display region 902.

In step S1502, the CPU 106 determines whether the checkbox is ticked, based on the acquired state of the checkbox. In a case where the checkbox is ticked (YES in step S1502), the processing proceeds to step S1503.

In step S1503, the CPU 106 acquires, from the management database 800, all records in which the same sound type as a sound type corresponding to the checkbox of which the state is switched to the ticked state, among list-displayed sound types is recorded. The CPU 106 adds information regarding the acquired records to a list and records the information.

In a case where the checkbox is not ticked (NO in step S1502), the processing proceeds to step S1504.

In step S1504, the CPU 106 deletes all records, among records recorded in the list, in which the same sound type as a sound type corresponding to the checkbox of which the state is switched to an unticked state is recorded.

In step S1505, the CPU 106 cancels the display of all range items in a case where there are range items displayed on the time-line region 305.

In step S1506, the CPU 106 acquires information regarding a start time and an end time, from records recorded in a list, and displays a range item onto the time-line region 305 over a period from the acquired start time to end time.

After the processing in step S1506, the processing in the flowchart in FIG. 15 ends.

As described above, according to the present exemplary embodiment, a word representing a sound type is displayed as information regarding a sound type, based on an analysis result of voice information. Furthermore, as information regarding a time at which sound corresponding to the displayed sound type is emitted, a display item indicating a time at which sound is emitted is displayed in a time-line region. Accordingly, even in a case where the user does not recognize sound emitted in a moving image, the user can easily identify a desired scene in the moving image (e.g., a scene required to be edited). In particular, by displaying a sound type, the user can use the sound type as a hint for identifying a desired scene in the moving image. In this manner, by enabling the user to easily identify the scene, it is possible to reduce work burden in editing a moving image.

Heretofore, the exemplary embodiments of the present disclosure have been described in detail, but the present disclosure is not limited to these specific exemplary embodiments, and various configurations without departing from the gist of the disclosure are also included in the present disclosure. The above-described exemplary embodiments may be partially combined as appropriate.

In the above-described exemplary embodiments, the description has been given of the case of highlighting the sentences 309 and 311 displayed on the moving image editing screen 300, by setting of the background color to a color different from the color of the background of other sentences, but a highlighting method is not limited to this case. For example, the sentences 309 and 311 may be highlighted by changing the size of characters, the color of characters, or the font type of characters.

In the above-described exemplary embodiments, the description has been given of the case of displaying a display item indicating a time at which sound is emitted, as information regarding a time at which sound is emitted, but a time display method is not limited to this case, and a start time and an end time may be displayed as numerical values.

According to an exemplary embodiment of the present disclosure, even in a case where the user does not recognize a sound emitted in a moving image, the user can identify a desired corresponding scene in the moving image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-097664, filed Jun. 17, 2024, which is hereby incorporated by reference herein in its entirety.

What is claimed is:

1. An information processing apparatus comprising:
one or more memories storing instructions; and
one or more processors in communication with the one or more memories, that upon execution of the stored instructions, configures the one or more processors to:
acquire voice information included in a moving image;
analyze the acquired voice information;
based on a result of the analysis, display information in a manner that allows for selection by a user, wherein the display information includes either or both of information indicating a speech error and information indicating a sound type included in the voice information; and
in accordance with information being selected by the user, display information regarding a time at which sound corresponding to the selected information is emitted.

2. The information processing apparatus according to claim 1, wherein a plurality of pieces of information of either or both of information indicating a speech error and information indicating a sound type included in the voice information is displayed in such a manner as to be selectable by a user.

3. The information processing apparatus according to claim 1,
wherein execution of the stored instructions causes the information processing apparatus to record sound corresponding to the displayed information, and a start time and an end time of a period during which the sound is emitted, in association with one another, and
wherein execution of the stored instructions causes the information processing apparatus to display information regarding the start time and the end time of the period during which the sound is emitted based on information recorded in association by the recording.

4. The information processing apparatus according to claim 3, wherein a display item indicating a start time and an end time of a period during which sound corresponding to the displayed information is emitted is displayed in a region in which a time-line indicating a time axis of the moving image is displayed.

5. The information processing apparatus according to claim 4, wherein the time-line is displayed in an enlarged manner and includes a predetermined time before and predetermined time after a time at which sound corresponding to the displayed information is emitted.

6. The information processing apparatus according to claim 1, wherein execution of the stored instructions causes the information processing apparatus to
convert the acquired voice information into a sentence;
extract, from the converted sentence, a sentence having incorrect grammar or a sentence with little relationship with preceding and succeeding sentences; and
display the extracted sentence.

7. The information processing apparatus according to claim 6, wherein the extracted sentence and an unextracted sentence are displayed in different modes.

8. The information processing apparatus according to claim 7, wherein the extracted sentence is displayed with greater emphasis than the unextracted sentence.

9. The information processing apparatus according to claim 6, wherein, among the extracted sentence having improper grammar, a sentence completed by one word is regarded as information regarding the speech error, and is not displayed.

10. The information processing apparatus according to claim 6, wherein, among the extracted sentence with little relationship with preceding and succeeding sentences, a later sentence is regarded as information regarding the speech error and is not displayed.

11. The information processing apparatus according to claim 6, wherein execution of the stored instructions further causes the information processing apparatus to delete a moving image corresponding to a time at which sound corresponding to the displayed information is emitted.

12. The information processing apparatus according to claim 11, wherein, in a case where the moving image is deleted, information regarding a speech error included in voice information of the deleted moving image is not displayed.

13. The information processing apparatus according to claim 1, wherein execution of the stored instructions causes the information processing apparatus to
extract a feature amount of sound included in the acquired voice information;
identify a sound type based on the extracted feature amount of the sound; and
display information regarding the identified sound type as a list.

14. The information processing apparatus according to claim 13, wherein, in a case where voice information in the moving image includes a plurality of sounds of a same type, each time sound of the same type is emitted, information regarding a time at which the sound is emitted is displayed.

15. The information processing apparatus according to claim 13, wherein, in a case where a plurality of pieces of information regarding different sound types are selected by a user, information regarding a time at which sound is emitted is displayed for each of the sound types.

16. The information processing apparatus according to claim 13,
wherein a user designates a section of the moving image, and
wherein execution of the stored instructions causes the information processing apparatus to display information regarding a type of sound emitted in the designated section.

17. The information processing apparatus according to claim 13, wherein information regarding the sound types is displayed with being sorted based on a type of the sound, a loudness of the sound, a length of a time during which the sound is emitted, or a timing at which the sound is emitted.

18. The information processing apparatus according to claim 13, wherein a display item indicating a time during which sound corresponding to the displayed information regarding the sound type is emitted is displayed in a region in which a time-line indicating a time axis of the moving image is displayed.

19. The information processing apparatus according to claim 18, wherein, in a case where a plurality of pieces of information regarding different sound types are selected by a user when times during which sounds corresponding to the selected information regarding the sound types are emitted overlap, the display item is displayed with a display mode being changed for each of the selected sound types.

20. The information processing apparatus according to claim 18, wherein, in a case where a plurality of pieces of information regarding different sound types are selected by a user when times during which sounds corresponding to the selected information regarding the sound types are emitted overlap, the display item is preferentially displayed in accordance with a display order of the displayed list.

21. The information processing apparatus according to claim 18, wherein, in a case where a plurality of pieces of information regarding different sound types are selected by a user when times during which sounds corresponding to the selected information regarding the sound types are emitted overlap, the display item is displayed in such a manner that an overlapping time is identifiable.

22. The information processing apparatus according to claim 1, wherein the sound type includes at least any of gunshot sound, music, klaxon, siren, cheer, notification sound, and wind sound.

23. The information processing apparatus according to claim 1, wherein the sound type is sound other than voice uttered by a person.

24. A control method of an information processing apparatus, the control method comprising:
acquiring voice information included in a moving image;
analyzing the voice information acquired by the acquiring;
first display of, based on an analysis result obtained by the analyzing, displaying information in a manner that allows for selection by a user, wherein the display
information includes either or both of information indicating a speech error and information indicating a sound type included in the voice information; and
second display of, in accordance with information being selected by the user, displaying information regarding a time at which sound corresponding to the selected information is emitted.

25. A non-transitory computer-readable storage medium storing a program for causing a computer to execute a control method that controls an information processing apparatus, the control method comprising:
acquiring voice information included in a moving image;
analyzing the voice information acquired by the acquiring;
first display of, based on an analysis result obtained by the analyzing, displaying information in a manner that allows for selection by a user, wherein the display information includes either or both of information indicating a speech error and information indicating a sound type included in the voice information; and
second display of, in accordance with information being selected by the user, displaying information regarding a time at which sound corresponding to the selected information is emitted.
